(19) United States
(12) Patent Application Publication
(10) Pub. No.: US 2023/0005081 A1
(43) Pub. Date: Jan. 5, 2023

(54) METHOD AND APPARATUS FOR PROVIDING COUNSELING SERVICE

(71) Applicant: KAKAO CORP., Jeju-si (KR)

(72) Inventors: Ho Jun LEE, Seongnam-si (KR); Yu Mi KIM, Seongnam-si (KR); Zong Muk YOON, Seongnam-si (KR); Jung Han CHOI, Seongnam-si (KR); Bo Mi HONG, Seongnam-si (KR); June Kwon MOON, Seongnam-si (KR); Ji Soo HWANG, Seongnam-si (KR); Hye Ryeon LEE, Seongnam-si (KR); Hyun Soo PARK, Seongnam-si (KR); Bo Kuk PARK, Seongnam-si (KR); Yeo Seong YOON, Seongnam-si (KR); Sang Hyeon SEO, Seongnam-si (KR); Jung Wook SON, Seongnam-si (KR)

(21) Appl. No.: 17/853,943

(22) Filed: Jun. 30, 2022

(30) Foreign Application Priority Data
Jun. 30, 2021 (KR) 10-2021-0086040

(51) Int. Cl. G06Q 50/00; H04L 51/02; H04L 51/046

(52) U.S. Cl. CPC G06Q 50/01; H04L 51/02; H04L 51/046

(57) ABSTRACT

A method of operating a counseling center server interworking with an instant messaging service includes, in response to a request for opening a counseling center of a channel registered in the service, creating a counseling center module corresponding to the channel, receiving a search request based on a message transmitted to a chat room of the channel included in the counseling center module, transmitting a query corresponding to the search request to a search medium interworking with the counseling center module based on an interworking structure of the counseling center module, the search medium comprising at least one of a knowledge database and a chatbot, creating a search result corresponding to the search request based on a response to the query received from the search medium, and requesting an instant messaging server providing the service to transmit the search result through the chat room.

### CROSS-REFERENCE TO RELATED APPLICATION

This application claims the benefit of Korean Patent Application No. 10-2021-0086040 filed on Jun. 30, 2021, in the Korean Intellectual Property Office, the entire disclosure of which is incorporated herein by reference for all purposes.

### BACKGROUND

### 1. Field of the Invention

One or more example embodiments relate to a method and apparatus for providing a counseling service.

### 2. Description of the Related Art

Recently, with development of mobile smart devices, the use of online platform services for interaction with other users through networks is increasing. Typical examples of the online platform services for interaction with other users include a social networking service (SNS), which is an online platform that creates and strengthens social relationships through communication, information sharing, and social network expansion among users, and an instant messaging service (IMS), which is an online platform for real-time content communication among two or more users. As the interaction among users through such mobile devices increases, the online platform service supports not only a chat service for daily conversation with other users, but also a function of providing various services based on communication among a plurality of users.

Contact center as a service (CCaaS) is a cloud-based service-type contact center solution may be a service that provides an online counseling platform with various counseling functions including a chat interface and a chatbot. There is a need for development of CCaaS technology for companies to efficiently conduct and manage counseling by applying smart technology while consumers may request non-face-to-face counseling using mobile devices in an easy and quick way.

### SUMMARY

According to an aspect, there is provided a method of operating a counseling center server interworking with an instant messaging service, including creating, in response to a request for opening a counseling center of a channel registered in the service, a counseling center module corresponding to the channel, receiving a search request based on a message transmitted to a chat room of the channel included in the counseling center module, transmitting a query corresponding to the search request to a search medium interworking with the counseling center module based on an interworking structure of the counseling center module, the search medium comprising at least one of a knowledge database and a chatbot, creating a search result corresponding to the search request based on a response to the query received from the search medium, and requesting an instant messaging server providing the service to transmit the search result through the chat room.

The interworking structure may include at least one of a structure in which the counseling center module and the chatbot of the channel interwork, a structure in which the counseling center module and a knowledge database registered in the server interwork, and a structure in which the counseling center module, the chatbot, and the knowledge database interwork.

The transmitting of the query corresponding to the search request may include at least one of transmitting the query to the chatbot interworking with the counseling center module, and transmitting the query to the knowledge database interworking with the counseling center module.

The creating of the search result may include receiving responses to the query and accuracies of the responses from the search medium, creating a search result, to correspond to each of the responses, including data included in the response, a type of the search medium transmitting the response, and the accuracy of the response, and sorting the created search results in order of the accuracies of the responses corresponding to the search results.

The requesting to transmit the search result may include, in response to an input for selecting the created search result, requesting the instant messaging server to transmit the selected search result.

The knowledge database may include a set of standard questions and answers.

The chatbot may include a bot configured to parse the query to extract intent and an entity, and create the response corresponding to the query based on the extracted intent and entity.

The chatbot may create the response corresponding to the query based on the knowledge database connected thereto.

According another aspect, there is provided a method of operating a counseling center server interworking with an instant messaging service, including creating, in response to a request for opening a counseling center of a channel registered in the service, a counseling center module corresponding to the channel, determining whether to enable the counseling center module and a search medium to interwork based on an interworking policy related to the counseling center module, the search medium comprising at least one of a knowledge database and a chatbot, controlling an interworking structure of the counseling center module based on the determination of whether to enable the counseling center module and the search medium to interwork, and providing a counseling service through a chat room for counseling of the channel based on the interworking structure.

The determining of whether to enable the counseling center module and the search medium to interwork may include at least one of determining to enable the counseling center module and a first chatbot to interwork through the channel when the channel interworks with the first chatbot, and determining to enable the counseling center module and a first knowledge database to interwork when connection information related to the first knowledge database is input to correspond to the counseling center module.

The connection information related to the first knowledge database may include at least one of identification information of the first knowledge database, and address of the first knowledge database.

The first chatbot interworking with the counseling center module may include a chatbot interworking with one of knowledge databases registered in the server.

The knowledge databases registered in the server may include at least one of the first knowledge database interworking with the counseling center module and a second knowledge database that does not interwork with the counseling center module.

According to another aspect, there is provided a counseling center sever including at least one processor configured to create, in response to a request for opening a counseling center of a channel registered, a counseling center module corresponding to the channel, receive a search request based on a message transmitted to a chat room for counseling of the channel, transmit a query corresponding to the search request to a search medium interworking with the counseling center module based on an interworking structure of the counseling center module, the search medium comprising at least one of a knowledge database and a chatbot, create a search result corresponding to the search request based on a response to the query received from the search medium, and transmit the search result as a message through the chat room.

The interworking structure may include at least one of a structure in which the counseling center module and the chatbot of the channel interwork, a structure in which the counseling center module and a knowledge database registered in the server interwork, and a structure in which the counseling center module, the chatbot, and the knowledge database interwork.

The processor may be configured to execute at least one of operations of, in transmitting the query corresponding to the search request, transmitting the query to the chatbot interworking with the counseling center module, and transmitting the query to the knowledge database interworking with the counseling center module.

The processor may be configured to, in creating the search result, receive responses to the query and accuracies of the responses from the search medium, create a search result, to correspond to each of the responses, including data included in the response, a type of the search medium transmitting the response, and the accuracy of the response, and sort the created search results in order of the accuracies of the responses corresponding to the search results.

The processor may be configured to, in transmitting the search result as a message through the chat room, transmit, in response to an input for selecting the created search result, the selected search result as the message through the chat room.

According to another aspect, there is provided a counseling center sever including at least one processor configured to create, in response to a request for opening a counseling center of a channel registered, a counseling center module corresponding to the channel, determine whether to enable the counseling center module and a search medium to interwork based on an interworking policy related to the counseling center module, the search medium comprising at least one of a knowledge database and a chatbot, control an interworking structure of the counseling center module based on the determination of whether to enable the counseling center module and the search medium to interwork, and provide a counseling service through a chat room for counseling of the channel based on the interworking structure.

The processor may be configured to execute at least one of operations of, in determining whether to enable the counseling center module and the search medium to interwork, determining to enable the counseling center module and a first chatbot to interwork through the channel when the channel interworks with the first chatbot, and determining to enable the counseling center module and a first knowledge database to interwork when connection information related to the first knowledge database is input to correspond to the counseling center module.

Additional aspects of example embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of example embodiments, taken in conjunction with the accompanying drawings of which:

FIG. 1 is a diagram illustrating an operation flowchart of a method of operating a counseling center server interworking with an instant messaging service according to an example embodiment;

FIG. 2 to FIG. 6 are diagrams illustrating an interworking structure of a counseling center module according to an example embodiment;

FIG. 7 is an operation flowchart illustrating a method of operating a counseling center server interworking with an instant messaging service according to an example embodiment;

FIG. 8 is a diagram illustrating a screen of an interface related to channel management according to an example embodiment;

FIG. 9 is a diagram illustrating a screen of an interface related to a counseling center module according to an example embodiment;

FIG. 10A and FIG. 10B are diagrams illustrating a screen of an interface related to a counseling center module supporting a search function according to an example embodiment;

FIG. 11 is a diagram illustrating a screen of an interface related to a counseling center module displaying a search result according to an example embodiment; and

FIG. 12 is an exemplary diagram illustrating a configuration of a counseling system according to an example embodiment.

### DETAILED DESCRIPTION

Although terms such as first or second may be used to describe various components, these terms should be interpreted only for the purpose of distinguishing one component from another. For example, a first component may be termed a second component, and similarly, a second component may also be termed a first component.

When a component is referred to as being “connected to” another component, it may be directly connected or coupled to the other component, but it should be understood that another component may exist therebetween.

The singular expression includes the plural expression unless the context clearly dictates otherwise. In the specification, terms such as “comprise” or “have” are intended to designate that the described feature, number, step, operation, component, part, or combination thereof exists, and it should be understood that the possibility of presence or addition of one or more other features or numbers, steps, operations, components, parts or combinations thereof is not excluded in advance.

Hereinafter, example embodiments will be described in detail with reference to the accompanying drawings. In describing with reference to the accompanying drawings, the same components are assigned with the same reference numerals regardless of the numerals on the drawings, and overlapping descriptions thereof will be omitted.

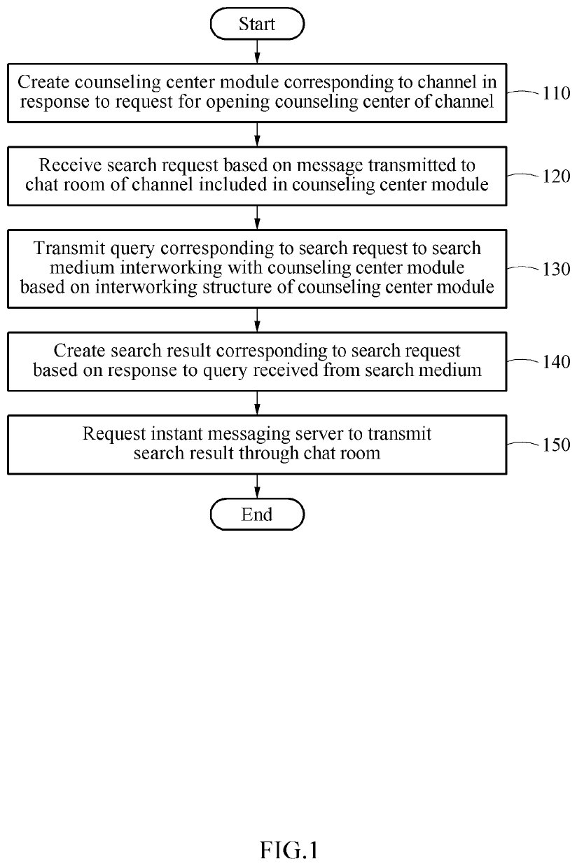

FIG. 1 is an operation flowchart illustrating a method of operating a counseling center server interworking with an instant messaging service according to an example embodiment.

Referring to FIG. 1, the method of operating a counseling center server interworking with an instant messaging service according to an example embodiment includes creating, in response to a request for opening a counseling center of a channel registered in the service, a counseling center module corresponding to the channel (110), receiving a search request based on a message transmitted to a chat room for counseling of the channel (120), transmitting a query corresponding to the search request to a search medium interworking with the counseling center module based on an interworking structure of the counseling center module (130), creating a search result corresponding to the search request based on a response to the query received from the search medium (140), and transmitting the search result as a message through the chat room (150).

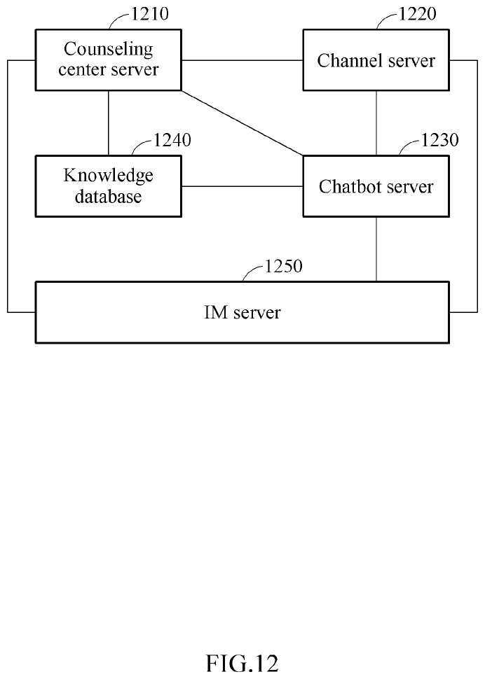

The counseling center server according to an example embodiment may correspond to a server that provides a counseling service by interworking with an instant messaging service. The counseling service is a counseling service that uses an instant messenger connected to an instant messaging server for providing an instant messaging service as a counseling medium, and a user may use the counseling service through a registered account or by subscribing to the instant messaging service. The counseling center server and the instant messaging server may be included in a counseling system for providing the counseling service, and a detailed configuration of the counseling system will be described in detail with reference to FIG. 12 below.

The instant messaging server according to an example embodiment may provide various types of accounts, such as a personal account, a corporate account, or a service account, to use the instant messaging service. The personal account may be an account for a general user, the corporate account may be an account for a specific company, and the service account may be an account for a specific service. The corporate account or the service account may be referred to as a channel.

The counseling service according to an example embodiment may be provided in the form of the counseling through a channel registered in the instant messaging service. Counseling through the channel may refer to the counseling conducted in a chatting manner between the channel and another account that requests the counseling on the channel. For example, the counseling service may be provided in a chatting manner using an instant messenger between a personal account (an individual account) of a first user corresponding to a general user and the channel of the second user corresponding to a specific company or a specific service provider. Hereinafter, the ‘counseling center server’ may be briefly referred to as a ‘server’.

Operation 110 according to an example embodiment may include creating the counseling center module corresponding to the channel in response to a request for opening a counseling center of the channel registered in the instant messaging service. The counseling center module is an instance created to correspond to the channel in the server, and may include data for providing and managing the counseling service for the channel. For example, the counseling center module may include data for providing counseling services such as account(s) of counselor(s) linked to the corresponding channel, chat room(s) created for channel counseling, counseling history, and counseling performance results. The counseling center module may correspond to the instance having a 1:1 correspondence with the channel, and the counseling center module corresponding to a specific channel may not correspond to another channel. The server may create and/or delete the counseling center module according to the request of the channel. The channel in which the counseling center module is created may use a counseling service function provided by the server.

According to an example embodiment, operation 110 may further include receiving the request for opening the counseling center from a terminal of a channel administrator. The request for opening the counseling center is a request to create the counseling center module corresponding to a specific channel registered in the server, it may be received from a terminal logged in with an account of an administrator of the channel or a terminal logged in with an account of the user authorized to manage the counseling center of the channel. Hereinafter, the ‘account of the administrator of the channel’ or the ‘account of the user authorized to manage the counseling center of the channel’ is referred to as the ‘account of the counseling center administrator’.

According to an example embodiment, the account of the counseling center administrator corresponding to the channel may be an account authorized to control and/or manage creating, deleting and interworking structure of the counseling center module corresponding to the channel, the account of registered counselor, and other data stored in the counseling center module. As an example, the server may provide an interface related to channel management to the terminal logged in with the account of the channel administrator, and the channel administrator may request the server to open the counseling center corresponding to the channel through the interface related to channel management. The interface related to channel management according to an example embodiment will be described in detail below.

According to an example embodiment, when the counseling center module corresponding to the channel is created, the account of the counseling center module administrator may register the account of the counselor linked to the channel in the counseling center module. The account of the counselor linked to the channel may be an account authorized to access to the chat room of the channel for counseling included in the counseling center module corresponding to the channel. The authority to access to the chat room of the channel may be the authority to transmit a message through the chat room of the channel using the channel, and receive the message transmitted through the chat room of the channel.

According to an example embodiment, the authority to access to the chat room of the channel of the account of the counselor linked to the channel may be limited to a part of the chat room of the channel. For example, the account of a first counselor may have access authority to a part allocated to the account of the first counselor among the chat rooms created for counseling of the channel, and the account of a second counselor may have access authority to the other part allocated to the account of the second counselor.

According to an example embodiment, when the counseling center module corresponding to the channel is created, the interface related to the counseling center module may be provided to the terminal logged in with the account of the counseling center administrator and the terminal logged in with the account of the counselor registered in the counseling center module. The counseling center administrator and the counselor may counsel with the account of the user who requested counseling by sending and receiving messages by accessing the chat room created for counseling through the interface related to the counseling center module provided in the terminal, and also may use functions related to the counseling service, such as using a search function to create the message for counseling. The interface related to the counseling center module according to an example embodiment will be described in detail below.

According to an example embodiment, the first user may request a counseling corresponding to the channel of a second user in which the counseling center module is created in the server using the terminal. As an example, the terminal of the first user terminal may receive an instruction of the first user for requesting counseling from a website or application linked to the channel of the second user, and transmit a signal to the server for requesting counseling through the channel of the second user. As another example, the terminal of the first user may request counseling on the channel of the second user to the server through the interface related to the channel of the second user provided by the instant messenger connected to the instant messaging server. In this case, the request for counseling on the channel of the second user may be transmitted to the counseling center server through the instant messaging server.

In response to an input for requesting counseling on the channel of the second user received from the terminal of the first user, the server according to an example embodiment may create a chat room for counseling of the channel of the second user in which the account of the first user participates. The chat room for counseling of the channel is a virtual chat space for counseling between the counselor linked to the channel and the user who requested counseling, the account of the counselor linked to the channel and the account of the user who requested counseling may counsel by sending and receiving messages through the chat room. The chat room created for counseling of the channel may be stored in the counseling center module corresponding to the channel.

According to an example embodiment, the counseling center module may interwork with at least one search medium. The search medium is a media used to obtain a search result for a search request, and may be used as means to assist the counselor using the counseling service according to an example embodiment to progress counseling. According to an example embodiment, the search medium may include a chatbot and/or a knowledge database.

According to an example embodiment, the chatbot is software designed to have a conversation or counseling with users. For example, the chatbot may include a bot implemented to parse an input query to extract intent and entity, and create a response corresponding to the query based on the extracted intent and entity.

According to an example embodiment, the knowledge database is a database storing data for conversation or counseling with users. For example, the knowledge database may include a database including a set of standard questions and answers, a database storing data about a specific product or service, and a database storing data about a specific user.

According to an example embodiment, the interworking structure of the counseling center module may include at least one of a structure in which the counseling center module and the chatbot of the channel interwork, a structure in which the counseling center module and the knowledge database registered in the server interwork, and a structure in which the counseling center module, the chatbot and the knowledge database interwork. The chatbot interworking with the counseling center module may mean a chatbot server.

According to an example embodiment, the interworking structure of the counseling center module may be determined based on whether the chatbot and the search medium including the knowledge database interwork. Whether the counseling center module and the search medium interwork may be determined based on a predefined interworking policy on the counseling center module.

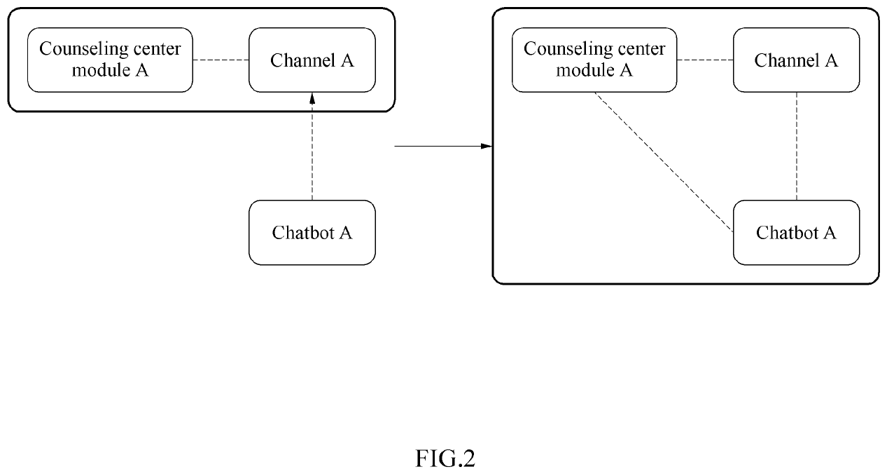

As an example, the interworking policy on interworking between the counseling center module and the chatbot may include a policy of interworking with the chatbot linked to the channel corresponding to the counseling center module. For example, referring to FIG. 2, when a channel A corresponding to the counseling center module A is linked to a chatbot A, a counseling center module A interwork with the chatbot A through the channel A. Hereinafter, the chatbot interworking with the counseling center module may mean a chatbot interworking with the counseling center module through the channel.

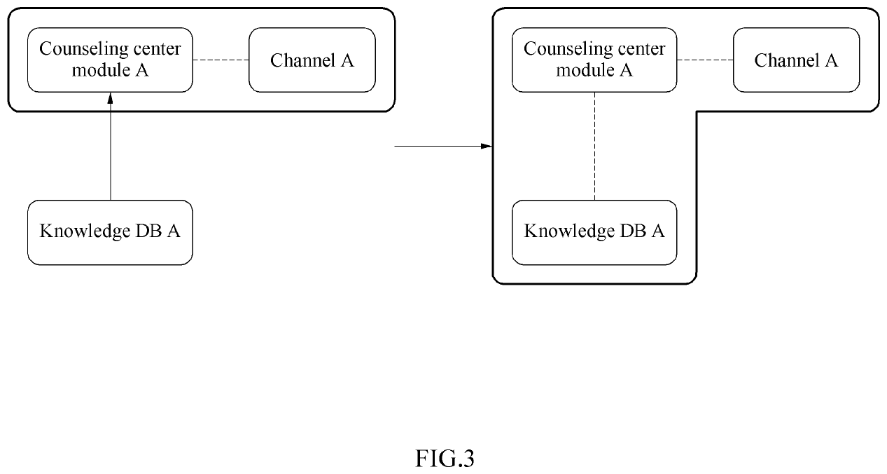

As another example, the interworking policy on interworking between the counseling center module and the knowledge database may include a policy of interworking with the knowledge database in which connection information is input to correspond to the counseling center module. For example, referring to FIG. 3, when connection information about a knowledge database A is input to the server to correspond to a counseling center module A, the counseling center module A may interwork with the knowledge database A.

According to an example embodiment, a plurality of knowledge databases may be registered in the server or another server accessible from the server, and the terminal logged in with the account of the user linked to the channel may upload the knowledge database to the server. The knowledge database uploaded by a specific user account may be owned by the account of the user, and access to the knowledge database may be authorized to an account of other user, the counseling center module corresponding to the channel of the other user, or the chatbot.

According to an example embodiment, the connection information about the knowledge database is information required to access the knowledge database, and may include, for example, at least one of identification information of the knowledge database and an address of the knowledge database. When connection information about a specific knowledge database is input to correspond to the counseling center module, the server may enable the counseling center module to interwork with the knowledge database, and the account of the counselor registered in the counseling center module may be authorized to access to the interworking knowledge database. In other words, when the server is received a request for data stored in the interworking knowledge database from the terminal logged in with the account of the counselor registered in the counseling center module, the server may access the knowledge database and transmit the data to the counselor's terminal. For example, the account of the administrator of the counseling center module may input the connection information about the first knowledge database owned by the administrator to correspond to the counseling center module, and the first knowledge database in which the connection information is input corresponding to the counseling center module may be the knowledge database interworking with the counseling center module.

According to an example embodiment, the knowledge database is not dependent on a specific counseling center module, and may interwork with at least one counseling center module and/or at least one chatbot. For example, the knowledge database A may interwork with the counseling center module A and a counseling center module B, and may interwork with a chatbot C interworking with a counseling center module C.

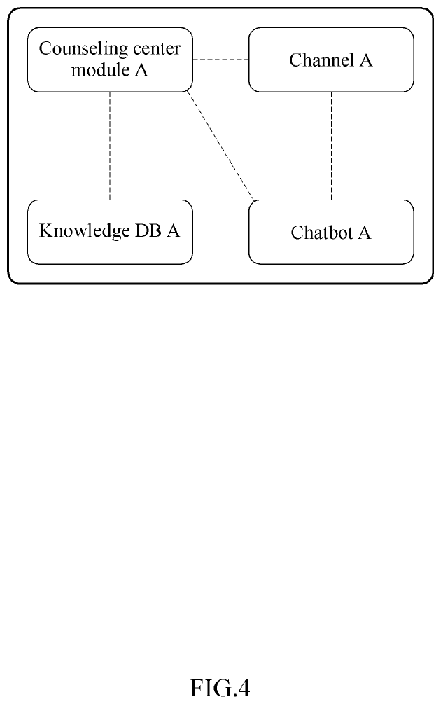

According to an example embodiment, the counseling center module may interwork with both the knowledge database and the chatbot. For example, referring to FIG. 4, the counseling center module A may interwork with the chatbot A linked to the channel A corresponding to the counseling center module A according to the interworking policy, and may interwork with the knowledge database A in which the connection information input.

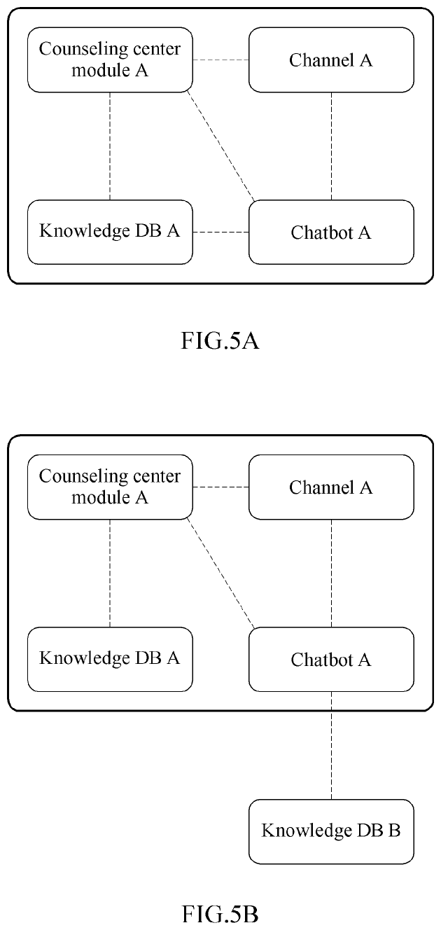

According to an example embodiment, the chatbot may interwork with the knowledge database. The chatbot may analyze the intent of the received message using the interworking knowledge database, or may create a response to the received message. For example, referring to FIG. 5A, the chatbot A interworking with the counseling center module A may interwork with the knowledge database A interworking with the counseling center module A. As will be described in detail below, in this case, the chatbot A may create a response to the query with reference to the knowledge database A, so that at least a part of the response to the query obtained based on the chatbot A is the query obtained based on the knowledge database A It may be the same as at least part of the response to. For another example, referring to FIG. 5B, the chatbot A interworking with the counseling center module A may interwork with the knowledge database B different from the knowledge database A interworking with the counseling center module A. In this case, the chatbot A may refer to the knowledge database B to create the response to the query.

According to an example embodiment, operation 120 may be an operation of receiving the search request based on the message transmitted to the chat room for counseling of the channel corresponding to the created counseling center module. The search request may be received from the terminal logged in with the account of the counselor linked to the counseling center module. The terminal of the account of the counselor registered in the counseling center module may access the chat room for counseling of the channel, and receive the message transmitted to the chat room. The counselor may request a search based on the message received from the server using the terminal logged in with the account of counselor.

According to an example embodiment, the search request based on the message transmitted to the chat room for counseling of the channel may include a search request for a search word determined by the counselor to respond to the message, a search request for a keyword extracted from the message, and a search request for the entire message. For example, if the message transmitted to the chat room for counseling of the channel is “I want to refund the shoes I bought”, the counselor who received the message may make a search request to the server using ‘refund’ as the search word, and make a search request using the entire message as the search word. When the search request using the entire message as the search word is received, the server may automatically extract a keyword and perform a search on the extracted keyword.

According to an example embodiment, operation 130 may include transmitting the query corresponding to the search request to the search medium including at least one of the knowledge database and the chatbot interworking with the counseling center module based on the interworking structure of the counseling center module.

According to an example embodiment, the query corresponding to the search request may be an instruction in which the search word corresponding to the search request is changed into a form for requesting data to the search medium. For example, when the search request is based on a specific keyword, the keyword or a value obtained by converting the keyword into a parameter corresponding to the search medium may be transmitted as the query. Alternatively, when the search request is based on the entire message, the keyword may be extracted from the message and the extracted keyword may be transmitted as the query, or the entire message may be transmitted as the query.

According to an example embodiment, operation 130 may include at least one of transmitting the query to the chatbot interworking with the counseling center module and transmitting the query to the knowledge database interworking with the counseling center module according to the interworking structure of the counseling center module. As described above, the counseling center module may form the interworking structure of interworking with the chatbot and/or the knowledge database according to the interworking policy. For example, when the counseling center module interworks with the chatbot, the query may be sent to the chatbot, when the counseling center module interworks with the knowledge database, the query may be sent to the knowledge database, when the counseling center module interworks with the chatbot and the knowledge database, the query may be sent to the chatbot and the knowledge database.

According to an example embodiment, operation 140 may include creating the search result corresponding to the search request received in operation 120 based on the response received in response to the query transmitted in operation 130 from the search medium. The response received in response to the query transmitted from the search medium may include the response to the query obtained from the knowledge database interworking with the counseling center module and the response to the query obtained from the chatbot interworking with the counseling center module.

According to an example embodiment, the knowledge database may output data stored by matching the query as the response to the input query. For example, when the answer is stored in the knowledge database by matching the standard question, the answer matching the question corresponding to the query and stored may be output as the response.

According to an example embodiment, the chatbot may output the response to the input query by using various methods according to general operation principles of the chatbot, such as rule-based, natural language processing-based and learning-based, and combinations of various methods.

As an example, the chatbot may interwork with the knowledge database, and the chatbot may create the response by referring to the interworking knowledge database. For example, when the chatbot interworks with the knowledge database interworking with the counseling center module, the response to the query obtained from the knowledge database may be created as the response of the chatbot. In this case, the response obtained from the chatbot may be the same as the response obtained from the knowledge database. Alternatively, the chatbot may interwork with other knowledge database that does not interwork with the counseling center module to create the response with reference to the other knowledge database.

The chatbot interworking with the knowledge database may flexibly process the input query to match the standard question stored in the knowledge database. More specifically, even if the input query is not grammatically identical to the standard questions stored in the knowledge database, a question most similar to the input query among the standard questions stored in the knowledge database may be researched. As an example, the chatbot may include a pre-trained artificial neural network-based model using a set of standard questions and answers stored in the knowledge database as training data.

According to an embodiment, a predetermined number of responses may be received to correspond to each search medium interworking with the counseling center module. For example, when all of the counseling center module, the knowledge database, and the chatbot interwork, the counseling center module may be set to receive 10 responses from the knowledge database and 1 response from the chatbot in response to the received search request.

According to an example embodiment, search result(s) corresponding to the search request may be created based on the response(s) received from the search medium. When there is a plurality of received responses, the search results may be created to correspond to each of the plurality of responses.

According to an example embodiment, operation 140 may further include, to correspond to each of the responses obtained from the search medium, creating the search result including data included in the response, a type of the search medium transmitting the response, and an accuracy of the response. In other words, the search result created in operation 140 may include data included in the response, and may further include information about the type of search medium from which the response was obtained and the accuracy of the response. The type of the search medium may include the type of the chatbot and the type of the knowledge database, and the information about the type of search medium from which the response was obtained may include information indicating that the response was obtained from the chatbot or obtained from the knowledge database. According to an example embodiment, the information about the type of search medium from which the response was obtained may further include information indicating that the response was obtained by referring to the knowledge database in the chatbot. In this case, the search result corresponding to the response created by the chatbot and the search result corresponding to the response created by the chatbot referring to the knowledge database connected to the chatbot may be displayed differently.

According to an example embodiment, operation 140 may include receiving responses to the query and the accuracies of the responses from the search medium, creating the search result corresponding to each of the received responses including the type of the search medium transmitting the response, the accuracy of the response, and data included in the response, and sorting the search results in order of the accuracies of the responses corresponding to the created search results. In other words, the plurality of search results corresponding to the plurality of responses may be sorted in order of high accuracy. The search results sorted in order of accuracy may be provided through the interface related to the counseling center module provided to the counselor's terminal. An example embodiment in which the search result is provided through the interface related to the counseling center module will be described in detail below.

According to an example embodiment, operation 150 may be an operation of requesting the instant messaging server to transmit the search result created in operation 140. The search result may be transmitted as a message from the instant messaging server through the chat room for counseling of the channel. The chat room to which the search result is transmitted may be a chat room for counseling of the channel of operation 120. In other words, the message corresponding to the search result may be an answer to the message received from the account of the user who requested the counseling through the chat room for the counseling of the channel in operation 120.

According to an example embodiment, operation 150 may include requesting transmission of the selected search result to the instant messaging server in response to the input for selecting the created search result.

When the selecting input for the created search result is received, the server may transmit the search result to the instant messaging server in response to the selecting input, and the instant messaging server may create the received search result as a message, and transmit the created message through the chat room. When the plurality of search results corresponding to the plurality of responses are created, the search result selected from among the plurality of search results created in response to the selecting input of the search result may be transmitted as a message. The input for selecting the search result may be received through the interface provided to the counselor's terminal. For example, the counselor may click any one of the search results provided to the terminal through the interface, and the counselor's terminal received the click input may transmit the selecting input for the search result to the server. According to an example embodiment, a preview of a message based on the selected search result may be provided to the terminal of the counselor.

According to an example embodiment, the selected search result may be transmitted to the chat room as a response message to the message received from the account of the user who requested the counseling through the chat room for counseling of the channel in operation 120.

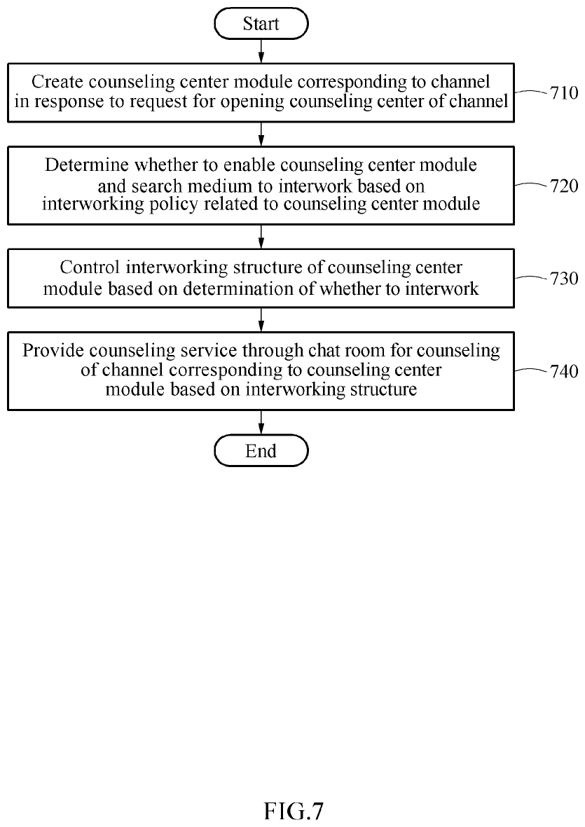

FIG. 7 is an operation flowchart illustrating a method of operating a counseling center server interworking with an instant messaging service according to an example embodiment.

Referring to FIG. 7, according to an example embodiment, the method of operating the counseling center server interworking with the instant messaging service may include creating, in response to a request for opening a counseling center of a channel registered in the service, a counseling center module corresponding to the channel (710), determining whether to enable the counseling center module and a search medium to interwork based on a interworking policy related to the counseling center module (720), controlling the interworking structure of the counseling center module based on the determination of whether to enable the counseling center module and the search medium to interwork (730), and providing the counseling service through a chat room for counseling of the channel corresponding to the counseling center module based on the interworking structure (740).

According to an example embodiment, operation 710 may correspond to operation 110 of FIG. 1 described above.

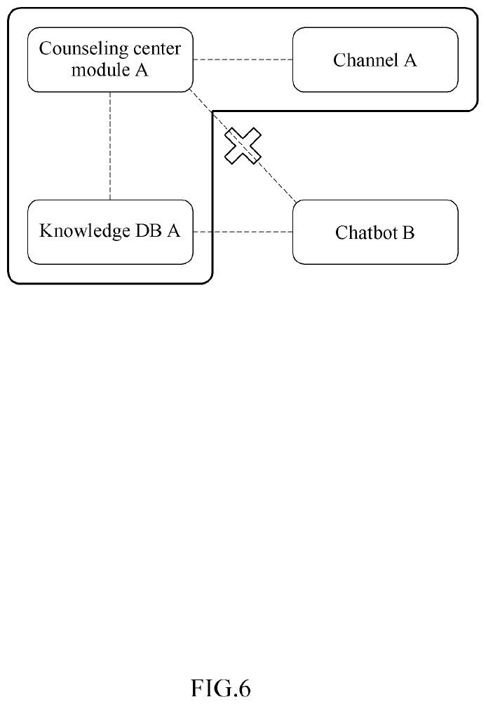

According to an example embodiment, in operation 720, the search medium may include at least one of the knowledge database and the chatbot as described above. In operation 720, the interworking policy may correspond to the interworking policy related to the counseling center module described above with reference to FIG. 2A to FIG. 6.

As an example, operation 720 of determining whether to enable the counseling center module and the search medium to interwork based on the interworking policy related to the counseling center module may include at least one of determining to enable the counseling center module and a first chatbot to interwork through the channel when the channel interworks with the first chatbot, and determining to enable the counseling center module and the first knowledge database to interwork when connection information related to the first knowledge database is input to correspond to the counseling center module.

According to an example embodiment, the first chatbot interworking with the counseling center module through the channel may include a chatbot interworking with any one of knowledge databases registered in the server, and the knowledge databases registered in the server may include the first knowledge database interworking with the counseling center module and a second knowledge database that does not interwork with the counseling center module. In other words, the first chatbot interworking with the counseling center module may interwork with the first knowledge database interworking with the counseling center module, or may interwork with the second knowledge database that does not interwork with the counseling center module.

As described above, the connection information about the first knowledge database is information required to access the first knowledge database, and may include, for example, at least one of identification information of the knowledge database and an address of the second knowledge database.

According to an example embodiment, operation 730 may be an operation of controlling the interworking structure of the counseling center module based on whether to enable the counseling center module and the search medium to interwork determined in operation 720. For example, if it is determined to enable the counseling center module and the first chatbot to interwork in operation 720, the server may control the interworking structure of the counseling center module by enabling the counseling center module the first chatbot to interwork. As another example, if it is determined to enable the counseling center module and the first knowledge database to interwork in operation 720, the server may control the interworking structure of the counseling center module by enabling the counseling center module and the first knowledge database to interwork.

According to an example embodiment, operation 730 may include releasing the interworking between the counseling center module and the search medium according to the interworking policy. For example, when interworking relationship between the first chatbot interworking with the counseling center module and the channel corresponding to the counseling center module is released, the server may release the interworking between the counseling center module and the first chatbot. As another example, when the access authority to the first knowledge database of the counseling center module is lost, such as when the first knowledge database interworking with the counseling center module does not belong to the administrator of the counseling center module, the server may release the interworking between the counseling center module and the first knowledge database.

According to an example embodiment, operation 740 may be an operation of providing the counseling service through the chat room for counseling of channel based on the interworking structure with the search medium of the counseling center module. As an example, as described above through operation 120 to 150 of FIG. 1, the counseling service may be provided by providing the search result for the search request as a message based on the interworking structure of the counseling center module.

According to an example embodiment, the counseling center module may be created in the instant messaging server. In this case, at least a part of the operations of the method of providing the counseling service performed in the counseling center server described above with reference to FIG. 1 to FIG. 7 may be performed in the instant messaging server.

As an example, an operating method of the instant messaging server may include creating the counseling center module corresponding to the channel in response to the request for opening the counseling center of the channel registered in the instant messaging service provided by the instant messaging server, receiving the search request based on the message transmitted to the chat room of the channel included in the counseling center module, transmitting the query corresponding to the search request to the search medium interworking with the counseling center module based on the interworking structure of the counseling center module, creating the search result corresponding to the search request based on the response to the query received from the search medium, and transmitting the created search result as a message through the chat room.

As another example, the operating method of the instant messaging server may include creating the counseling center module corresponding to the channel in response to the request for opening the counseling center of the channel registered in the instant messaging service provided by the instant messaging server, determining whether to enable the counseling center module and the search medium to interwork based on the interworking policy related to the counseling center module, controlling the interworking structure of the counseling center module based on the determination of whether to enable the counseling center module and the search medium to interwork, and providing the counseling service through the chat room for counseling of the channel based on the interworking structure.

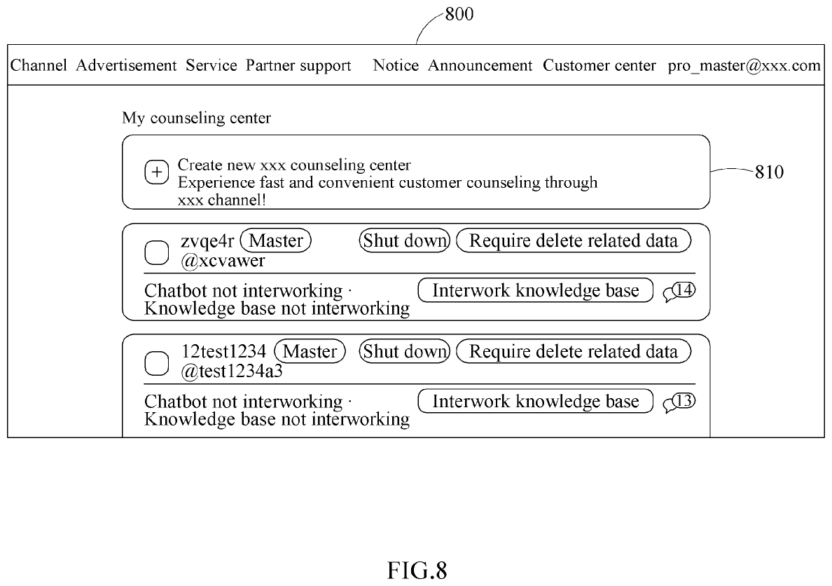

FIG. 8 is a diagram illustrating a screen of the interface related to channel management according to an example embodiment.

Referring to FIG. 8, according to an example embodiment, an interface 800 related to channel management may be provided to the terminal logged in with the account of the administrator of the channel. The interface 800 related to channel management may include an interfacing object 810 for request for opening the counseling center.

The interfacing object is a configuration implemented to interact with users within the interface, and may include, for example, an object that may receive input from users while providing specific information (e.g., visual information) with users. The interfacing object may include a button implemented to perform a predetermined function (e.g., switching to another screen) by the selecting input (e.g., click) of users.

According to an example embodiment, the administrator of the channel may request the server to open the counseling center corresponding to the channel by performing the input (e.g., click) for selecting the interfacing object 810. The server received the request for opening the counseling center from the terminal of the administrator of the channel through the interface 800 may create the counseling center module corresponding to the channel.

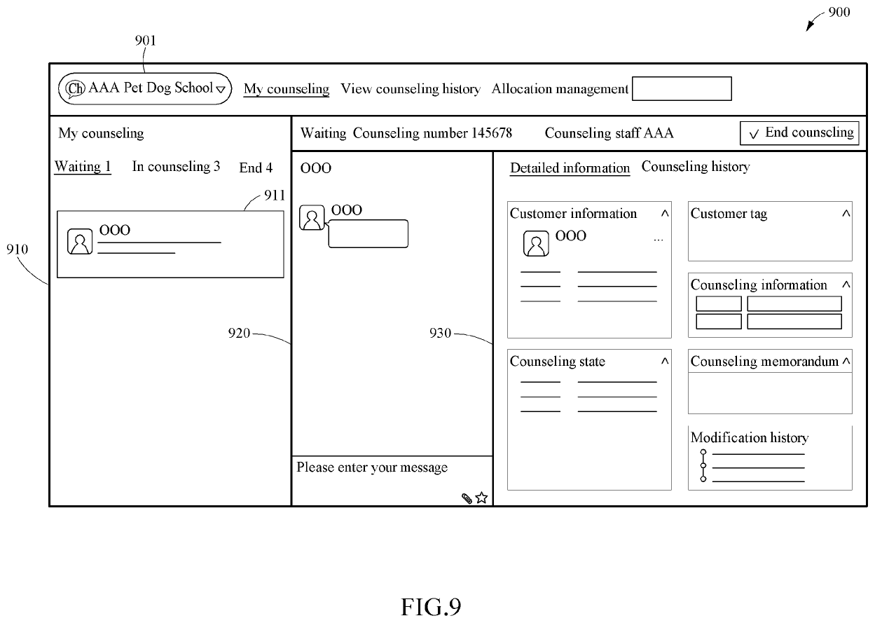

FIG. 9 is a diagram illustrating the screen of the interface related to the counseling center module according to an example embodiment.

Referring to FIG. 9, according to an example embodiment, an interface 900 related to the counseling center module corresponding to a specific channel 901 may be provided to the terminal logged in with the account of the counselor linked to the channel (hereinafter, referred to as ‘terminal of counselor’). The interface 900 provided to the terminal of the counselor may include a list 910 of chat rooms allocated to the account of the counselor. By selecting (e.g., clicking) an interfacing object 911 related to the chat room displayed in the list of chat rooms, the counselor may request the server to access to the chat room. For example, when the counselor requests the server to access to the chat room by clicking the interfacing object 911 related to the chat room, the server may provide a chat window 920 corresponding to the chat room on the terminal of the counselor in response to the access request. The terminal of the counselor may request the server to transmit a message to the account of the user participating in the chat room in response to the message input of the counselor through the chat window 920. The counselor may counsel with the user by sending and receiving messages with the account of the user participating in the chat room through the chat window 920.

According to an example embodiment, the chat interface 900 may further include a window 930 for providing information about counseling in addition to the list 910 of the chat room and the chat window 920. Information about counseling may include, for example, information about the user who requested counseling, information about the state of counseling, and information about the duration of counseling.

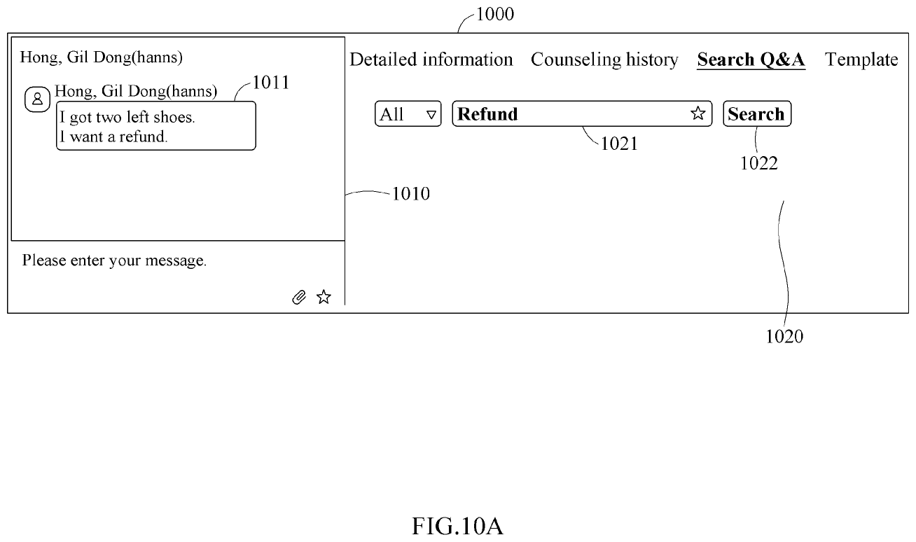

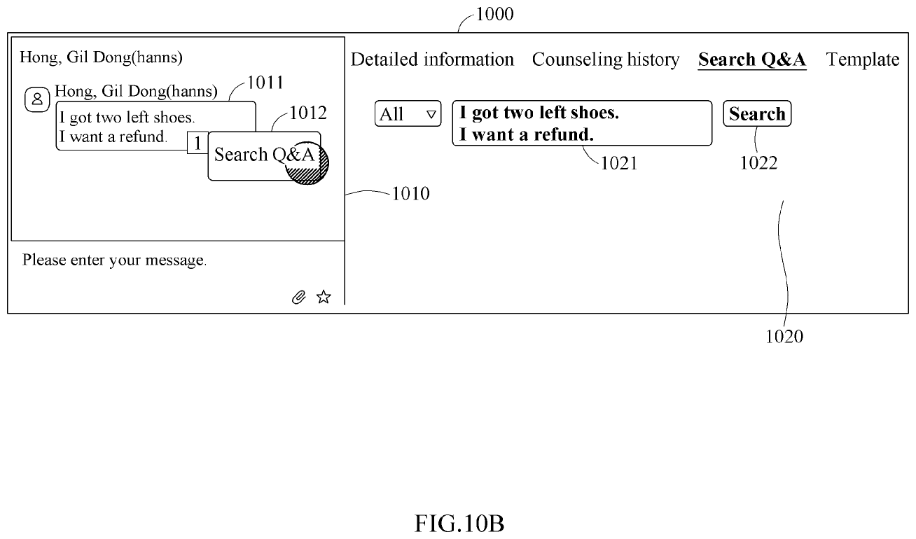

FIG. 10A and FIG. 10B are diagrams illustrating the screen of the interface related to the counseling center module supporting the search function according to an example embodiment.

As described above, the counselor linked to a specific channel may access the chat room of the channel created for counseling through the interface related to the counseling center module provided to the terminal and counsel with the user account who requested counseling in a chatting manner, and may use the search function to create a message for counseling.

Referring to FIG. 10A and FIG. 10B, an interface 1000 related to the counseling center module provided to the terminal of the counselor may transmit the search request to a chat window 1010 corresponding to the chat room and the server, and include a search interface 1020 for the search function receiving the search result. A message 1011 transmitted to the chat room for counseling may be displayed through the chat window 1010, and the counselor may request the server to search for a specific search word based on the message 1011 through a search window 1021 included in the search interface 1020.

As described above, according to an example embodiment, the search request based on the message transmitted to the chat room for counseling of the channel may include the search request for the search word determined by the counselor to respond to the message. For example, referring to FIG. 10A, the counselor may directly input the search word (e.g., ‘refund’) into the search window 1021 based on the message received through the chat room (e.g., a message for requesting counseling on a refund), and may select a ‘search’ button 1022 after entering the search word. The terminal of the counselor may transmit a signal requesting a search for the entered search word to the server in response to the input of the counselor selecting the ‘search’ button 1022.

As described above, according to an example embodiment, the search request based on the message transmitted to the chat room for counseling of the channel may include the search request for the entire message. For example, referring to FIG. 10B, the chat window 1010 may provide a function to transmit to the server the search request for the entire message by the input (e.g., click) for selecting an interfacing object 1012 that requests the search on the message 1011. The terminal of the counselor may enter the entire message in the search window 1021 as the search word in respond to the input of the counselor selecting (e.g., clicking) the interfacing object 1012 requesting the search on the message 1011 displayed on the chat window 1010. After the entire message is entered in the search window 1021, the terminal of the counselor may transmit the signal requesting the search for the inputted search word to the server in respond to the input of the counselor selecting the ‘search’ button 1022.

According to an example embodiment, the terminal of the counselor may transmit the signal requesting the search for the entire message to the server in respond to the input of the counselor selecting (e.g., clicking) the interfacing object 1012 requesting the search about the message 1011 displayed on the chat window 1010. In other words, the signal requesting the search for the entire message may immediately transmitted to the server, without entering the message 1011 displayed on the chat window 1010 as the search word in the search window 1021.

As described above, the server received the search request may transmit the query corresponding to the search request to the search medium (e.g., the chatbot and/or the knowledge database) interworking with the counseling center module, and may create the search result corresponding to the search request based on the response to the query received from the search medium.

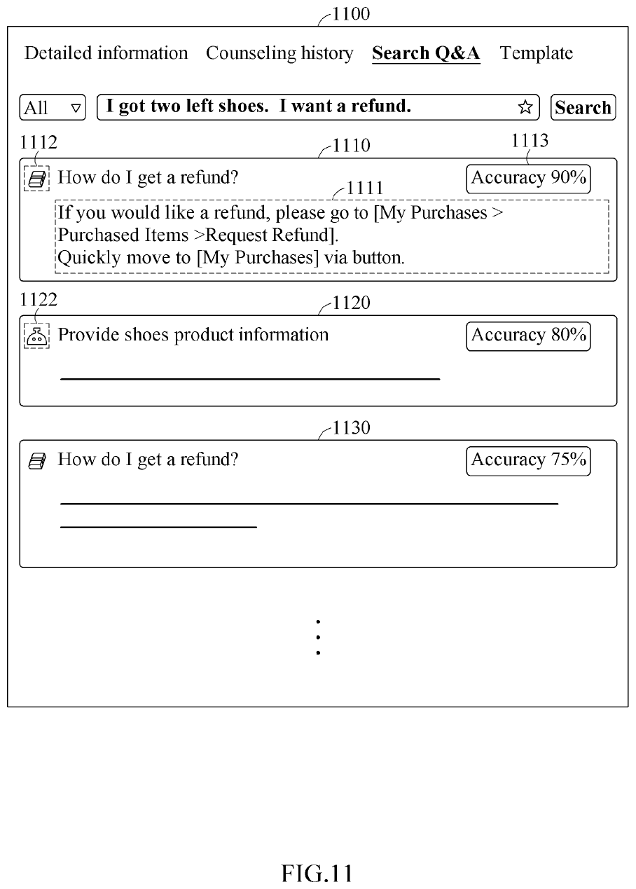

FIG. 11 is a diagram illustrating the screen of the interface related to the counseling center module displaying the search result according to an example embodiment.

Referring to FIG. 11, search results 1110, 1120, and 1130 created by the server may be provided to the terminal of the counselor who has transmitted the search request signal through an interface 1100 related to the counseling center module. As described above, the search result may be created in response to the response received from the search medium, and when a plurality of responses are received from the search medium, a plurality of search results corresponding to the plurality of responses may be created.

As described above, the search result corresponding to the response obtained from the search medium may include data included in the response, the type of the search medium transmitted the response, and accuracy of the response. For example, a search result 1110 may include data 1111 included in the corresponding response, a visual indicator 1112 indicating the type of the search medium transmitted the response, and an accuracy 1113 of the response.

According to an example embodiment, the interface 1100 provided to the terminal of the counselor may include the visual indicator indicating the type of the search medium sent the response corresponding to the search result, thereby providing the counselor with information about whether the search result is based on the response obtained from the chatbot, or is obtained from the knowledge database. For example, the visual indicator 1112 indicating the type of the search medium included in the search result 1110 may be a visual indicator indicating the type of search database. The visual indicator 1122 indicating the type of the search medium transmitted the response included in the search result 1120 may be a visual indicator indicating the type of the chatbot.

According to an embodiment, the interface 1100 provided to the terminal of the counselor may display the accuracy of the response corresponding to the search result, thereby providing information useful for the counselor to determine whether to use the created search result as the answer for counseling.

As described above, a plurality of search results corresponding to a plurality of responses may be sorted in order of high accuracy, and search results sorted in order of high accuracy may be displayed on the interface 1100.

According to an example embodiment, the terminal of the counselor may receive the input for selecting a specific search result, and may transmit the signal for message transmission request for the selected search result to the server. The server may request the instant messaging server to transmit the selected search result, and the instant messaging server may create the selected search result as a message and transmit to the account of the user who requested counseling through the chat room.

FIG. 12 is an exemplary diagram illustrating a counseling system configuration according to an example embodiment.

Referring to FIG. 12, a counseling system according to an example embodiment may include a counseling center server 1210, a channel server 1220, a chatbot server 1230, a knowledge database 1240, and an instant messaging server (hereinafter, IM server) 1250.

The counseling system may perform an operation related to a counseling service executed in a chatting manner between a personal account of the first user corresponding to a general user and the channel of the second user corresponding to a specific company or a specific service provider. The counseling center server 1210 may create the counseling center module corresponding to the channel of the second user according to the request of the second user, and register the account of the counselor linked to the channel of the second user to correspond to the counseling center module. The counselor linked to the channel of the second user may communicate with the counseling center server 1210 through a counseling center app installed in the terminal or a counseling center web connected from the terminal of the counselor using the account of the counselor, and may send and receive messages through the chat room by accessing the chat room of the channel of the second user. The first user may communicate with the IM server 1250 through an instant messaging app installed in the terminal or an instant messaging web connected from the terminal using the account of the first user, and may send and receive messages through the chat room by accessing the chat room of the channel of the second user.

According to an example embodiment, the terminal of the first user accessed the chat room of the channel of the second user may transmit a message to the chatbot, or may transmit a message to the counselor linked to the channel of the second user. The recipient of the message may be determined according to the type of counseling progressed in the chat room. For example, when the type of counseling progressed in the chat room of the channel of the second user is the a first counseling type corresponding to unmanned counseling, the recipient may be determined as the chatbot interworking with the channel of the second user, when the type of counseling progressed in the chat room of the channel of the second user is the a second counseling type corresponding to manned counseling, the recipient may be determined as the counselor linked to the channel of the second user.

According to an example embodiment, the message transmitted from the terminal of the first user through the chat room of the channel is transmitted to the IM server 1250, and the IM server 1250 may transmit the message to the counseling center server 1210 or the chatbot server 1230. For example, the IM server 1250 may transmit the message to the counseling center server 1210 if the message is transmitted to the counselor, and may transmit the message to the chatbot server 1230 if the message is transmitted to the chatbot. The message transmitted to the chatbot server 1230 may be transmitted from the chatbot server 1230 to the counseling center server 1210. The chatbot server 1230 may create a response message to the message, and transmit the created response message to the terminals of users through the IM server 1250.

According to an example embodiment, the message transmitted from the terminal of the first user through the chat room of the channel is transmitted to the IM server 1250, the IM server 1250 may transmit the message to the channel server 1220, and then the channel server 1220 may transmit the message to the counseling center server 1210 or the chatbot server 1230. The channel server 1220 may process the branching of the path to which the message is transmitted, and if the message is a message transmitted to the counselor, the message may be transmitted to the counseling center server 1210, and if the message is a message transmitted to the chatbot, the message may be transmitted to the chatbot server 1230.

According to an example embodiment, when a counseling ticket corresponding to the chat room of the channel to which the message is transmitted is not created, the counseling center server 1210 may create a counseling ticket corresponding to the chat room. The counseling ticket is a unit in which counseling is objectified in the server, and the counseling ticket may correspond to a session for counseling between a specific user and the counselor linked to a specific channel or a chatbot. The type of the counseling ticket may be determined based on the counseling type of counseling progressed in the chat room to which the message is transmitted. For example, if the counseling type at the time the message is transmitted is the first counseling type corresponding to unmanned counseling, a counseling ticket for the first type may be created, if the counseling type at the time the message is transmitted is the second counseling type corresponding to manned counseling, a counseling ticket for the second type may be created. According to an example embodiment, it may capable of requesting the counseling center server 1210 to create the counseling ticket while transmitting the message from the chatbot server 1230 to the counseling center server 1210. The counseling center server 1210 received the request for creating the counseling ticket from the chatbot server 1230 may create the counseling ticket of the first type.

The counseling center server 1210 may allocate the counseling ticket of the second type created to correspond to the chat room of the channel of the second user to any one of the account of the counselor linked to the channel of the second user. The counseling center server 1210 may transmit the message received through the chat room corresponding to the counseling ticket of the second type to the terminal of the counselor to which the counseling ticket is allocated. The terminal of the counselor may request transmission of the message through the chat room corresponding to the counseling ticket allocated to the counseling center server 1210, and the counseling center server 1210 may transmit the message to the terminal of the user connected to the chat room through the IM server 1250.

According to an example embodiment, the terminal of the counselor may request the search for the message transmitted to the chat room corresponding to the counseling ticket allocated to the counseling center server 1210. As described above, the counseling center server 1210 may transmit the search request to the chatbot server 1230 and/or the knowledge database 1240 based on the interworking structure of the counseling center module corresponding to the channel.

According to an example embodiment, the counseling center server may include a processor and a memory.

The processor of the counseling center server according to an example embodiment may perform at least one operation described above with reference to FIG. 1 to FIG. 11. For example, the processor may perform operations of the counseling center server interworking with the instant messaging service described above in FIG. 1 and/or operations of the counseling center server interworking with the instant messaging service described above in FIG. 7. In addition, the interface described above with reference to FIG. 8 to FIG. 11 may be provided to the terminal of the counselor.

According to an example embodiment, the memory of the counseling center server is a computer-readable recording media, and may be a volatile memory or a non-volatile memory. According to an example embodiment, the memory according to may store information related to the provision of the counseling service described above with reference to FIG. 1 to FIG. 11. As an example, the memory of the server may store accounts of users registered in the server, and may store the counseling center module created to correspond to the channel registered in the server.

According to an example embodiment, the memory of the counseling center server may store a program implemented at least one operation described above with reference to FIG. 1 to FIG. 11. The processor of the counseling center server may execute the program stored in the memory, and control the server. A code of the program executed by the processor of the counseling center server may be stored in the memory.

The example embodiments described herein may be implemented using hardware components, software components, or a combination thereof. For example, the apparatus, method, and components described in the example embodiments may be implemented using a general purpose computer or special purpose computer, for example, a processor, a controller, an arithmetic logic unit (ALU), a digital signal processor, a microcomputer, a field programmable gate array (FPGA), a programmable logic unit (PLU), a microprocessor, or any other device capable of executing and responding to instructions. The processing device may run an operating system (OS) and one or more software applications that run on the OS. The processing device also may access, store, manipulate, process, and create data in response to execution of the software. For purpose of simplicity, the description of a processing device is used as singular, however, one skilled in the art will appreciated that a processing device may include multiple processing elements and multiple types of processing elements. For example, a processing device may include multiple processors or a processor and a controller. In addition, different processing configurations are possible, such as parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums.

The methods according to the above-described example embodiments may be recorded in non-transitory computer-readable media including program instructions to implement various operations which may be performed by a computer. The media may also include, alone or in combination with the program instructions, data files, data structures, and the like. The program instructions recorded on the media may be those specially designed and constructed for the purposes of the example embodiments, or they may be of the well-known kind and available to those having skill in the computer software arts. Examples of non-transitory computer-readable media include magnetic media such as hard disks, floppy disks, and magnetic tape; optical media such as CD ROM discs and DVDs; magneto-optical media such as optical discs; and hardware devices that are specially configured to store and perform program instructions, such as read-only memory (ROM), random access memory (RAM), flash memory, and the like. Examples of program instructions include both machine code, such as code produced by a compiler, and files containing higher level code that may be executed by the computer using an interpreter.

The described hardware devices may be configured to act as one or more software modules in order to perform the operations of the above-described example embodiments, or vice versa.

While this disclosure includes example embodiments, it will be apparent to one of ordinary skill in the art that various changes in form and details may be made in these example embodiments without departing from the spirit and scope of the claims and their equivalents. Suitable results may be achieved if the described techniques are performed in a different order, and/or if components in a described system, architecture, device, or circuit are combined in a different manner and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A method of operating a counseling center server interworking with an instant messaging service, the method comprising:
creating, in response to a request for opening a counseling center of a channel registered in the service, a counseling center module corresponding to the channel;
receiving a search request based on a message transmitted to a chat room of the channel included in the counseling center module;
transmitting a query corresponding to the search request to a search medium interworking with the counseling center module based on an interworking structure of the counseling center module, the search medium comprising at least one of a knowledge database and a chatbot;
creating a search result corresponding to the search request based on a response to the query received from the search medium; and
requesting an instant messaging server providing the service to transmit the search result through the chat room.

2. The method of claim 1, wherein the interworking structure comprises at least one of:
a structure in which the counseling center module and the chatbot of the channel interwork;
a structure in which the counseling center module and a knowledge database registered in the server interwork; and
a structure in which the counseling center module, the chatbot, and the knowledge database interwork.

3. The method of claim 1, wherein the transmitting of the query corresponding to the search request comprises at least one of:
transmitting the query to the chatbot interworking with the counseling center module; and
transmitting the query to the knowledge database interworking with the counseling center module.

4. The method of claim 1, wherein the creating of the search result comprises:
receiving responses to the query and accuracies of the responses from the search medium;
creating a search result, to correspond to each of the responses, including data included in the response, a type of the search medium transmitting the response, and the accuracy of the response; and
sorting the created search results in order of the accuracies of the responses corresponding to the search results.

5. The method of claim 1, wherein the requesting to transmit the search result comprises, in response to an input for selecting the created search result, requesting the instant messaging server to transmit the selected search result.

6. The method of claim 1, wherein the knowledge database comprises a set of standard questions and answers.

7. The method of claim 1, wherein the chatbot comprises a bot configured to parse the query to extract intent and an entity, and create the response corresponding to the query based on the extracted intent and entity.

8. The method of claim 1, wherein the chatbot creates the response corresponding to the query based on the knowledge database connected thereto.

9. A method of operating a counseling center server interworking with an instant messaging service, the method comprising:
to creating, in response to a request for opening a counseling center of a channel registered in the service, a counseling center module corresponding to the channel;
determining whether to enable the counseling center module and a search medium to interwork based on an interworking policy related to the counseling center module, the search medium comprising at least one of a knowledge database and a chatbot;
controlling an interworking structure of the counseling center module based on the determination of whether to enable the counseling center module and the search medium to interwork; and
providing a counseling service through a chat room for counseling of the channel based on the interworking structure.

10. The method of claim 9, wherein the determining of whether to enable the counseling center module and the search medium to interwork comprises at least one of:
determining to enable the counseling center module and a first chatbot to interwork through the channel when the channel interworks with the first chatbot; and
determining to enable the counseling center module and a first knowledge database to interwork when connection information related to the first knowledge database is input to correspond to the counseling center module.

11. The method of claim 10, wherein the connection information related to the first knowledge database comprises at least one of:
identification information of the first knowledge database; and
address of the first knowledge database.

12. The method of claim 10, wherein the first chatbot interworking with the counseling center module comprises a chatbot interworking with one of knowledge databases registered in the server, and
the knowledge databases registered in the server comprises at least one of the first knowledge database interworking with the counseling center module and a second knowledge database that does not interwork with the counseling center module.

13. A computer program stored in a non-transitory computer-readable medium in combination with hardware to execute the method of claim 1.

14. A counseling center sever comprising:
at least one processor configured to:
create, in response to a request for opening a counseling center of a channel registered, a counseling center module corresponding to the channel;
receive a search request based on a message transmitted to a chat room for counseling of the channel;
transmit a query corresponding to the search request to a search medium interworking with the counseling center module based on an interworking structure of the counseling center module, the search medium comprising at least one of a knowledge database and a chatbot;
create a search result corresponding to the search request based on a response to the query received from the search medium; and
transmit the search result as a message through the chat room.

15. The counseling center sever of claim 14, wherein the interworking structure comprises at least one of:
a structure in which the counseling center module and the chatbot of the channel interwork;
a structure in which the counseling center module and a knowledge database registered in the server interwork; and
a structure in which the counseling center module, the chatbot, and the knowledge database interwork.

16. The counseling center sever of claim 14, wherein the processor is configured to execute at least one of operations of:
in transmitting the query corresponding to the search request,
transmitting the query to the chatbot interworking with the counseling center module; and
transmitting the query to the knowledge database interworking with the counseling center module.

17. The counseling center sever of claim 14, wherein the processor is configured to:
in creating the search result,
receive responses to the query and accuracies of the responses from the search medium;
create a search result, to correspond to each of the responses, including data included in the response, a type of the search medium transmitting the response, and the accuracy of the response; and
sort the created search results in order of the accuracies of the responses corresponding to the search results.

18. The counseling center sever of claim 14, wherein the processor is configured to, in transmitting the search result as a message through the chat room, transmit, in response to an input for selecting the created search result, the selected search result as the message through the chat room.

19. A counseling center sever comprising:
at least one processor configured to:
create, in response to a request for opening a counseling center of a channel registered, a counseling center module corresponding to the channel;
determine whether to enable the counseling center module and a search medium to interwork based on an interworking policy related to the counseling center module, the search medium comprising at least one of a knowledge database and a chatbot;
control an interworking structure of the counseling center module based on the determination of whether to enable the counseling center module and the search medium to interwork; and
provide a counseling service through a chat room for counseling of the channel based on the interworking structure.

20. The counseling center sever of claim 19, wherein the processor is configured to execute at least one of operations of:
in determining whether to enable the counseling center module and the search medium to interwork,
determining to enable the counseling center module and a first chatbot to interwork through the channel when the channel interworks with the first chatbot; and
determining to enable the counseling center module and a first knowledge database to interwork when connection information related to the first knowledge database is input to correspond to the counseling center module.
